(19) United States
(12) Patent Application Publication
(10) Pub. No.: US 2008/0061955 A1
(43) Pub. Date: Mar. 13, 2008

(54) ANTENNA SYSTEM FOR A VEHICLE

(75) Inventors: Tom Q. Tang, Novi, MI (US); Riad Ghabra, Dearborn, MI (US); Jason Summerford, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/468,371

(22) Filed: Aug. 30, 2006

(51) Int. Cl. B60C 23/00; G08B 13/14

(52) U.S. Cl. 340/447; 340/572.7

(57) ABSTRACT

The teachings of the present invention include an antenna system for a tire pressure monitoring system. The antenna system includes an antenna coil that is printed on the circuit board in a manner that is cost-efficient and that enhances the signal reception. In one embodiment, the antenna coil is printed planar to the circuit board.

### TECHNICAL FIELD

The present invention relates to an antenna system for a vehicle.

### BACKGROUND

Tire pressure monitoring (TPM) systems are commonly installed on vehicles. The TPM systems include a transmitter, which transmits encoded signals to a TPM sensor within the vehicle. The sensor is configured to decode the received signals and to transmit the decoded signals to a microprocessor within the vehicle. Conventionally, these TPM sensors utilize a low-frequency (LF) antenna that enable wireless reception of the signals. The antenna is conventionally a discrete ferrite core coil. It is well known that these antennas are costly, which increases the cost of the overall TPM system. Thus, there is a need for an antenna system with reduced cost while being capable of optimal reception of transmitted signals.

### SUMMARY

The teachings of the present invention include an antenna system for a tire pressure monitoring system (TPM). The antenna system includes a circuit board and an antenna coil that is printed on the circuit board. In one aspect, the antenna coil receives a triggering signal that causes the TPM system to operate. Additionally, in one embodiment, the antenna coil is printed substantially planar with the circuit board.

A method of manufacturing the antenna system is also provided through the use of the teachings of the present invention. The method includes the step of providing a circuit board. In one embodiment, the circuit board is a printed circuit board. The method also includes the step of printing the antenna coil on the circuit board, wherein the antenna coil is configured to receive triggering signals that cause the TPM system to operate. In one aspect of the present invention, the antenna coil is printed substantially planar with the circuit board.

### BRIEF DESCRIPTION OF THE DRAWINGS

The features of the present invention which are believed to be novel are set forth with particularity in the appended claims. The present invention, both as to its organization and manner of operation, together with further advantages thereof, may be best understood with reference to the following description, taken in connection with the accompanying drawings in which:

FIG. 1 illustrates a vehicle having a tire pressure monitoring (TPM) system with an antenna system in accordance with teachings of the present invention;

FIG. 2 illustrates a block diagram of a TPM sensor in accordance with the teachings of the present invention; and

FIG. 3 is a flow chart of a method for manufacturing and installing a TPM system having an antenna system in accordance with the teachings of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

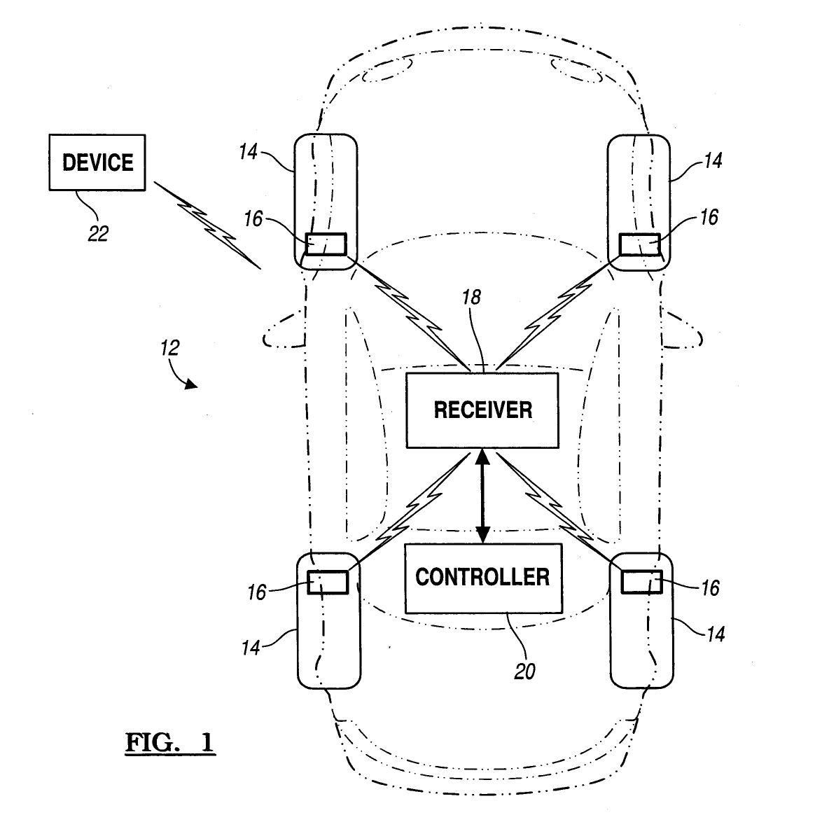

Now, referring to FIG. 1, a vehicle 12 is shown having a tire pressure monitoring (TPM) system with an antenna system in accordance with teachings of the present invention. The vehicle 12 includes a set of wheels 14, in which tire pressure sensors 16 are located. It is recognized that in some embodiments, tire pressure sensor 16 may be located within a spare tire of a vehicle. As such, tire pressure sensor 16 may be directly coupled to or integrated with a valve stem (not shown) of wheels 14. Tire pressure sensor 16 is configured to receive signals, sense the tire pressure of wheels 14 and wirelessly transmit encoded signals indicative of the tire pressure to a receiver 18. Accordingly, the receiver 18 transmits the signals to a controller 20. Controller 20 is configured to process and decode messages received from receiver 18 and determine the condition of wheels 14 (e.g., over-inflated or under-inflated). The controller may then transmit data relating to the condition to a display (not shown) on vehicle 12 to notify a vehicle operator of the condition.

As described above, sensor 16 includes an antenna system that enables the reception of signals from devices located on vehicle 10 as well as external devices, such as device 22. According to the teachings of the present invention, sensor 16 may have a low frequency (LF) antenna for receiving signals. The signals received by sensor 16 may be triggering signals that cause the sensor 16 to wake-up or cause the sensor 16 to perform some function. It is recognized that in some embodiments, the LF antenna may also function as a radio-frequency (RF) antenna and transmit signals to various receivers within the vehicle (e.g., receiver 18). In one aspect of the present invention, the antenna system having the LF antenna may operate within a frequency range including, but not limited to, 20 kilo-hertz (KHz) to 140 kilo-hertz (KHz).

As described in the foregoing, the antenna system may receive signals from external devices, such as the device 22. Device 22 may be a hand held or stationary diagnostic tool that transmits signals to vehicle 12 so as to initiate, for example, a TPM diagnostic algorithm. It is also recognized that device 22 may be used to program the TPM system including sensor 16.

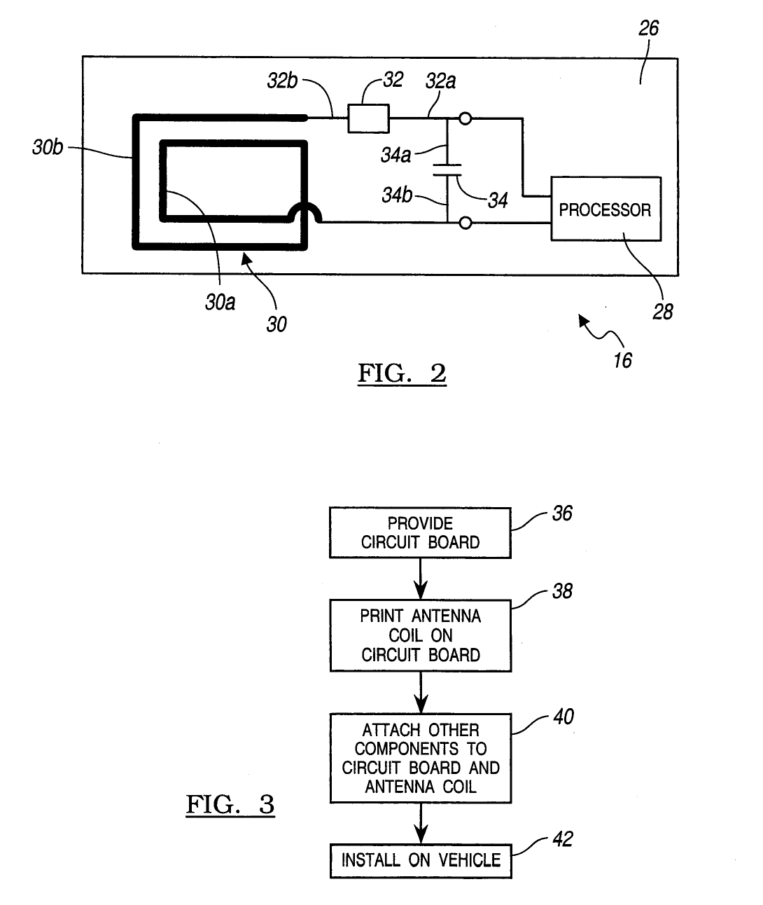

Now, referring to FIG. 2, is a detailed illustration of a sensor 16 is provided. As shown, sensor 16 includes a circuit board 26, a processor 28, and an antenna coil 30. In one embodiment, the circuit board 26, is a printed circuit board (PCB) formed of at least one layer of semiconductor type material. Accordingly, it is recognized that circuit board 26 may have a plurality conductive tract that enable the flow of electricity throughout the sensor 16.

As described above, sensor 16 is adapted to receive signals (e.g., LF signals) from the vehicle or external devices. Once sensor 16 receives the signals, they are processed by a processor 28. Processor 28 may functions as a memory and data processing device thereby transforming the received signals into specific commands for the TPM system. As such, processor 28 may have memory storage capability and be programmed to store data and algorithms for TPM operations.

Signals received and processed by processor 28 are initially received through the use of antenna coil 30. In one aspect, antenna 30 may be formed of a conductive material such as a conductive wire and the like. In alternative embodiments, antenna coil 30 may be formed of a conductive material including, but not limited to, aluminum, steel, a metal alloy, and the like. Nevertheless, it is recognized that antenna coil 30 may be formed of virtually any material so long as antenna coil 30 can sufficiently receive and transmit LF signals.

As shown, antenna coil 30 is printed on circuit board 26. In one aspect, the antenna coil 30 is printed planar with the circuit board 26. Antenna coil 30 also includes a first antenna loop 30a and a second antenna loop 30b. Also as shown, antenna loop 30b substantially encloses or encircles antenna loop 30a. The configuration of antenna coil 30 as shown causes it to have an increased coil cross section as compared to convention TPM antennas. The increased coil cross section enables antenna coil 30 to receive an appreciable amount of magnetic flux, which enhances signal reception. In one aspect of the present invention, antenna coil 30 may have a cross section in the range of one inch to two inches. It is recognized, however, that alternative embodiments may have an antenna coil cross section that varies from the embodiments described herein without departing from the scope of the present invention.

Nevertheless, once antenna coil 30 receives a transmitted signal, the signals are converted into electrical signals and are manipulated by electronic components including an inductor 32 and a capacitor 34. Inductor 32 enables the circuit to develop a sufficient amount of inductance to optimize performance of sensor 16. Inductor 32 includes a first inductor terminal 32a and a second inductor terminal 32b. As shown, inductor terminal 32b is directly coupled to antenna coil 30. In one aspect, the inductor 32 is a surface mounted device (SMD). It is recognized however that other types of inductors may be utilized without departing from the scope of the present invention.

As described above, a capacitor 34 is included which filters signals received by antenna coil 30. Capacitor 34 has a first capacitor terminal 34a and a second capacitor terminal 34b. As shown, the first capacitor terminal 34a is directly coupled to the first inductor terminal 32a. Additionally, second capacitor terminal 34b is directly coupled to a second end of antenna coil 30. Once the signals received by antenna coil 30 are received by inductor 32 and capacitor 34, the signals are in a form to be received by processor 28.

Now, referring to FIG. 3, a flow chart is provided that is directed to a method of manufacturing and installing the TPM sensor. Accordingly, block 36 depicts the circuit board being provided. As described above, the circuit board may preferably be a printed circuit board. Block 38 depicts printing the antenna coil on the circuit board. As stated above, the antenna coil may have a plurality of loops including antenna loops 30a and 30b (FIG. 2). Block 40 illustrates the attachment of other components (e.g., inductor 32, capacitor 34, processor 28 and the like) to the circuit board and coupling of these components to the antenna coil. Additionally, block 42 depicts the installation of the sensor into the vehicle. In one embodiment as provided above, the sensor is installed within the wheels of the vehicle. The order of the flow chart in FIG. 3 is merely exemplary. Alternative embodiments may have an order that varies from that shown in FIG. 3, but does not depart from the scope of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An antenna system for a tire pressure monitoring system comprising:
a circuit board;
an antenna coil printed on the circuit board, wherein the antenna coil receives triggering signals adapted to cause the tire pressure monitoring system to operate.

2. The system of claim 1, wherein the antenna coil is printed substantially planar with the circuit board.

3. The system of claim 1, further comprising an inductor that is coupled to the antenna coil.

4. The system of claim 3, wherein the inductor is in the form of a surface mounted device.

5. The system of claim 4, further comprising a capacitor that is coupled to the inductor.

6. The system of claim 5, wherein the circuit board, the antenna coil, the inductor, and the capacitor form a tire pressure monitoring sensor.

7. The system of claim 1, wherein the circuit board is a printed circuit board.

8. The system of claim 1, wherein the antenna coil is a low-frequency (LF) antenna and the antenna coil is adapted to transmit radio-frequency (RF) signals.

9. A method of manufacturing an antenna system for a tire pressure monitoring system comprising:
providing a circuit board;
printing an antenna coil on the circuit board, wherein the antenna coil is configured to receive triggering signals that cause the tire pressure monitoring system to operate.

10. The method of claim 9, wherein the antenna coil is printed substantially planar with the circuit board.

11. The method of claim 9, further comprising an inductor that is coupled to the antenna coil, the inductor

12. The method of claim 11, wherein the inductor is in the form of a surface mounted device.

13. The method of claim 12, further comprising a capacitor that is coupled to the inductor.

14. The method of claim 9, wherein the circuit board is a printed circuit board.

15. The method of claim 9, wherein the antenna coil is a low-frequency (LF) antenna.

16. The method of claim 9, wherein printing the antenna coil on the circuit board includes printing an antenna coil having a first antenna loop and a second antenna loop.

17. An antenna system for a tire pressure monitoring system comprising:
a printed circuit board;
a capacitor mounted to the circuit board, wherein the capacitor has a first capacitor terminal and a second capacitor terminal;
an inductor mounted to the circuit board and having a first inductor terminal and a second inductor terminal, wherein the inductor is coupled to the first capacitor terminal via the first inductor terminal; and
a low-frequency antenna coil printed on the circuit board and coupled to the inductor at the second inductor terminal and coupled to capacitor at the second capacitor terminal, the antenna coil forming a first and a second loop and receiving a triggering signal from a transmitting device.

18. The system of claim 17, wherein the second loop substantially encloses the first loop.

19. The system of claim 17, wherein the antenna coil is printed substantially planar with the circuit board.

20. The system of claim 17, wherein the inductor is in the form of a surface mounted device.
